(19) United States
(12) Patent Application Publication
(10) Pub. No.: US 2015/0034579 A1
(43) Pub. Date: Feb. 5, 2015

(54) Folding Shelf Carriage

(71) Applicant: Madix, Inc., Terrell, TX (US)

(72) Inventors: Shawn Michael Kahler, Heath, TX (US); Don Richard Doyle, JR., Waverly, AL (US)

(73) Assignee: Madix, Inc., Terrell, TX (US)

(21) Appl. No.: 13/955,762

(22) Filed: Jul. 31, 2013

(51) Int. Cl. B62B 3/02

(52) U.S. Cl. CPC B62B 3/02
USPC 211/85.8; 211/13.1

(57) ABSTRACT

An apparatus for carrying and/or storing shelves which is capable of folding into a compact condition to minimize the footprint of the device when not in use for carrying or storing shelves. The apparatus includes a releasable transverse cross member extending between the side frames to form a base for supporting shelves.

### FIELD OF THE DISCLOSURE

The invention relates generally to the field of shelving storage and organization.

### BACKGROUND

Many industries utilize shelving for display, organization, and storage of goods, materials and tools. In retail stores, shelving is often used to display goods for sale. In many retail stores, shelving resets are common. For example, shelves may be repositioned on the sales floor to accommodate new merchandising. During these resets, the number of shelves in use may vary. Often retailers need to hide away extra retail shelves that may not be used during certain merchandising. In addition, shelves may become unusable over time due to normal wear and tear or other causes. Accordingly, retail stores may maintain a supply of shelves in storage in a back room or closet.

Moveable carts for storing unconnected shelves facilitate efficiency through mass movement of the shelves during the rearrangement and repositioning of the shelves for merchandising resets. In addition, they may make accommodation of the stored shelving easier within the back room or closet. However, the space within the back room is limited in many retail establishments, and moveable carts often occupy the same amount of space regardless of whether they are empty or holding shelves in storage.

Designs for some display units which might be used for storing shelves include side walls that fold to a position adjacent to the back wall to conserve space when stored. Such displays are not well designed for storing and moving retail shelves and do not include elements sufficient to support an unconnected shelf. Some designs for compactable carts have been developed in which a floor and side walls can be folded to a position adjacent to a back wall to conserve space when stored. Such carts are often bulky because they include a complete floor and have a wide profile to accommodate the folded floor section.

### SUMMARY

An improved apparatus for storing and organizing shelves while providing a minimal footprint when not in use is disclosed. The apparatus includes a back, two foldable sides and a transverse support member which can be detachably connected between the two sides to hold them in an open condition to store shelving.

When the apparatus is not in use for storing shelves, it can be folded to create a minimal storage footprint for the apparatus. The transverse support member may be unconnected from one side and moved into a vertical position over the other side. The sides may then fold into a position aligned with the back.

In some embodiments, the frame of the apparatus may be designed from tubular components. In some embodiments, the apparatus does not include any paneling or other material between the structural frame components. For example, the back may be open between horizontal frame components along the back and vertical frame components along the sides.

While the back and sides could be provided by panels, it is preferred that they comprise frame members, such as tubular components.

In some embodiments, the apparatus may include shelf attachment components to support shelves during storage or transport. For example, vertical frame members may include notches or openings, such as vertical slots, which are spaced to accept prongs, hooks, and/or other shelf brackets associated with a shelf. In some embodiments, the transverse frame member and the horizontal lower portions of the side frames create the lower support surface for stacking shelves.

In some embodiments, the apparatus includes wheels or other components to provide mobility to the apparatus. In some embodiments, the apparatus includes a strap or other system to secure the shelving in place.

### A BRIEF DESCRIPTION OF THE DRAWINGS

Embodiments will now be described, by way of example only, with references to the accompanying drawings in which:

FIG. 1 is a perspective view of an embodiment of a shelf carriage in an open state;

FIG. 2 is an enlarged view of a hinge of the shelf carriage shown in FIG. 1;

FIG. 3 is an enlarged view of a removable connection of the shelf carriage shown in FIG. 1;

FIG. 4 a perspective view of an embodiment of a shelf carriage in a folded state; and

FIG. 5 is a perspective view of another embodiment of a shelf carriage in an open state.

### DETAILED DESCRIPTION

While this invention may be embodied in many different forms, there will herein be described in detail preferred embodiments of the invention with the understanding that the present disclosure is to be considered as an exemplification of the principles of the invention and is not intended to limit the broad aspects of the invention to the embodiments illustrated. It will be understood that the invention may be embodied in other specific forms without departing from the spirit or central characteristics thereof. The present embodiments, therefore, are to be considered in all respects as illustrative and not restrictive, and the invention is not to be limited to the details given herein. The apparatus for storing and organizing shelves may be referred to as a shelf carriage, trolley and/or cart in this disclosure.

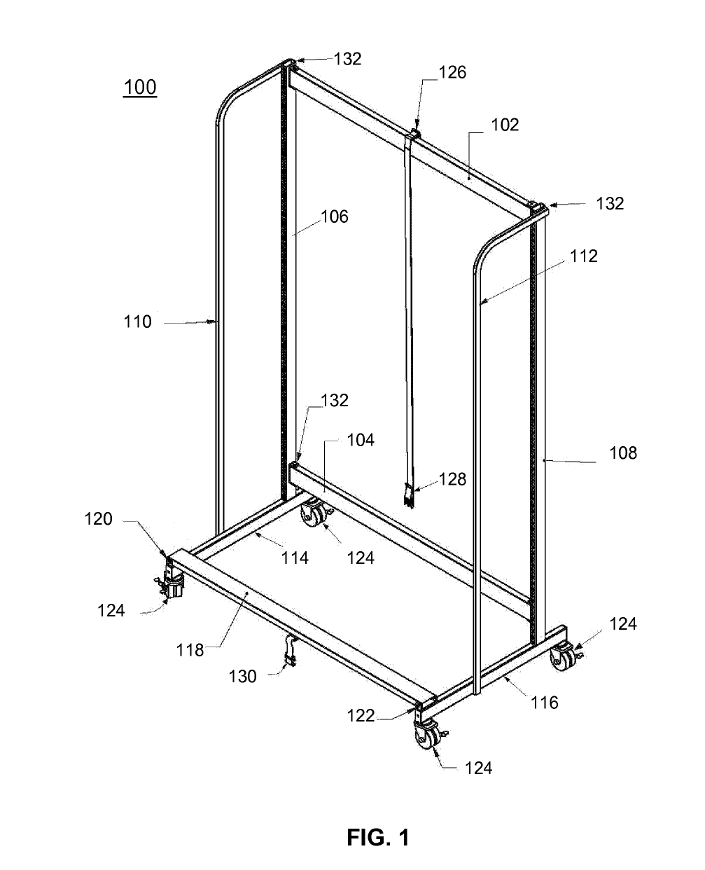

FIG. 1 depicts an embodiment of a shelf carriage 100 in an open state or condition. In the open state, the shelf carriage 100 may be used to store, carry and/or transport one or more shelves.

Shelf carriage 100 comprises a number of frame components defining a back, sides and a bottom. In this embodiment, the back of shelf carriage 100 is defined by the upper back frame member 102 and lower back frame member 104 which are both horizontal frame components. The horizontal back frame members 102 and 104 are attached by hinges 132 at their outer ends to a first vertical frame member 106 and a second vertical frame member 108. The hinges 132 facilitate a structural connection which allows axial movement or rotation of the back frame members 102 and 104 with respect to the vertical frame members 106 and 108. The back in this embodiment is open between horizontal back frame members 102 and 104 and the vertical frame members 106 and 108. In such an embodiment, the weight of the shelf carriage 100 may be minimized by only utilizing frame components necessary for the structure and leaving out components such as a back panel. In other embodiments, a panel, board and/or other material may be included to cover the area between horizontal back frame members 102 and 104 and the vertical frame members 106 and 108. Accordingly, the back may be an open or a closed area defined by the structural frame members.

The components of a first side of the shelf carriage 100 include the first vertical frame member 106, a first vertical side rail member 110 extending toward the front of said shelf carriage 100 and a first horizontal side frame member 114 located near the bottom of the shelf carriage 100. Similarly, the components of a second side of shelf carriage 100 include the second vertical frame member 108, a second vertical side rail member 112 extending toward the front of said shelf carriage 100 and a second horizontal side frame member 116 located near the bottom of the shelf carriage 100.

In the open condition shown in FIG. 1, a transverse frame member 118 extends from the first horizontal side frame member 114 to the second horizontal side frame member 116, and is attached to the first horizontal side frame member 114 by first connection 120 and attached to the second horizontal side frame member 116 by second connection 122. In some embodiments of the shelf carriage 100, first connection 120 and/or second connection 122 may comprise detachable connections.

In the depicted embodiment, the shelf carriage 100 includes a set of four casters 124 which facilitate movement of the shelf carriage 100 which are operatively attached to the first horizontal side frame member 114 and the second horizontal side frame member 116. In addition, FIG. 1 depicts a strap 126 which may be used to secure the shelves to the shelf carriage 100.

In an open state, such as that shown in FIG. 1, the shelf carriage 100 may be used to store and/or carry shelves. In the open state shown, the side components are substantially perpendicular to the back of the shelf carriage 100. In some embodiments, the vertical frame members 106 and 108 are designed such that shelves to be moved or stored are attachable to the vertical frame members 106 and 108 by one or more shelf support connections, such as spaced openings, engaging protrusions, or other connections for attaching a shelf to the shelf carriage. For example, the vertical frame members 106 and 108 may include spaced openings which receive hooks provided on the shelves whereby the hooks of a shelf fit into the spaced openings and engage the vertical frame members 106 and 108 to support the shelf on the shelf carriage 100.

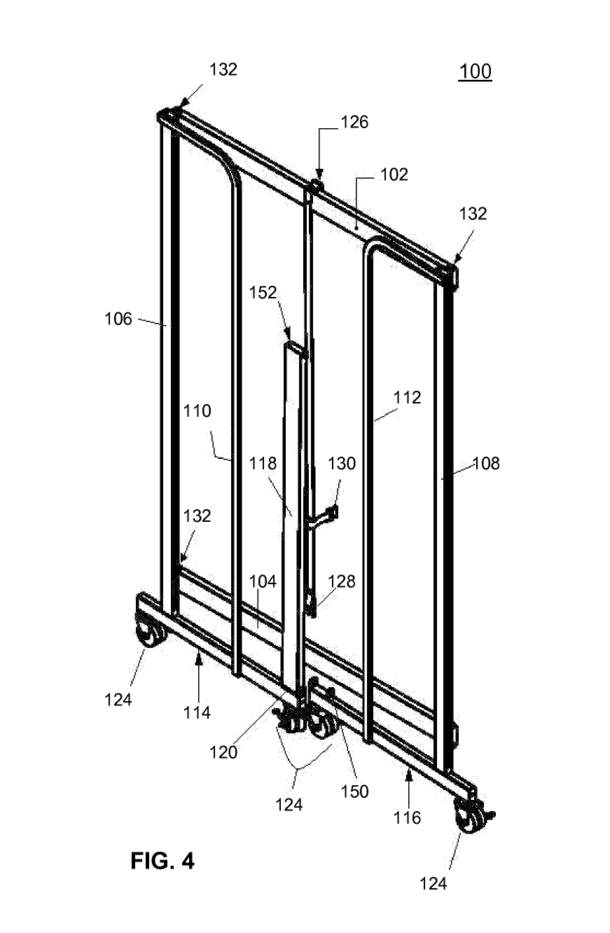

As discussed further below in conjunction with FIG. 4 (depicting an embodiment of shelf carriage 100 in a closed or folded state), the shelf carriage 100 may be folded to minimize the floor footprint in some embodiments by disconnecting the transverse frame member 118 from the second horizontal side frame member 116, and rotating the disconnected transverse frame member 118 to a vertical position. The side components may then be rotated inward to a closed state or condition adjacent to the back of shelf carriage 100 around the hinges 132 which provide a rotatable connection between the horizontal back frame members 102 and 104 and the vertical frame members 106 and 108. This reduces the depth and therefore the overall footprint of the shelf carriage 100 for storage without the shelves.

In some embodiments, one or more back frame members 102 and 104 may be positioned at a variety of heights. In some embodiments, the back may include one or more vertical frame components. In some embodiments, the back may include angular frame components, such as a pair of diagonal members creating the shape of an “X” across the back of the shelf carriage 100. The number of horizontal, vertical and/or angular frame components for the back of shelf carriage 100 may vary.

In some embodiments, the horizontal back frame members 102 and 104 may also be attached such that the height of one or more of the horizontal back frame members 102 and 104 may be variable. For example, the horizontal upper back frame member 102 may be attached to the hinges 132 which allow the horizontal upper back frame member 102 to slide up or down along a portion of the vertical frame members 106 and 108. One skilled in the art will recognize that any connection to the back of shelf carriage 100 that provides for the side frame components to rotate or pivot may be utilized and remain within the scope and spirit of the present disclosure.

In this embodiment, the first vertical side rail member 110 extends vertically upward from the first horizontal side frame member 114 and then curves near the top and extends horizontally to the first vertical frame member 106. In this embodiment, the first vertical side rail member 110 is attached to the outside of the first vertical frame member 106. In addition, the first vertical side rail member 110 is attached to the outside of the first horizontal side frame member 114 approximately halfway between the first vertical frame member 106 and the end of the first horizontal side frame member 114. One skilled in the art will recognize that the placement of connections for the side components may vary and remain within the scope and spirit of the present disclosure. The first horizontal side frame member 114 extends primarily forward from the back of the shelf carriage 100. In some embodiments, the first horizontal side frame member 114 also extends partially behind the back of the shelf carriage 100.

In this embodiment, the second vertical side rail member 112 extends vertically from the second horizontal side frame member 116 upward then curves near the top and extends horizontally to the second vertical frame member 108. In this embodiment, the second vertical side rail member 112 is attached to the outside of the second vertical frame member 108. In addition, the second vertical side rail member 112 is attached to the outside of second horizontal side frame member 116 approximately halfway between the second vertical frame member 108 and the end of the second horizontal side frame member 116. One skilled in the art will recognize that the placement of connections for the side components may vary and remain within the scope and spirit of the present disclosure. The second horizontal side frame member 116 extends primarily forward from the back of the shelf carriage 100. In some embodiments, the second horizontal side frame member 116 also extends partially behind the back of the shelf carriage 100.

In some embodiments, first connection 120 is a rotatable connection, such as a hinge, which facilitates movement of the transverse frame member 118 at least between a near horizontal position and a near vertical position. In some embodiments, second connection 122 is a detachable connection which facilitates a structurally sound connection when said shelf carriage 100 is in an open state, and allows the transverse frame member 118 and the second horizontal side frame member 116 to be disconnected for folding the shelf carriage 100. The type of connections may vary and remain within the scope and spirit of the disclosure. For example, first connection 120 may be a removable connection and second connection 122 may be a rotatable connection. As another example, both connections 120 and 122 may be detachable connections.

The frame members may be connected in a variety of manners including bolts, screws, adhesives, tapes, welds, friction connections, fitted connections, rotatable connections, removable connections and/or other connections. In some embodiments, frame members are combined into singular structures. For example, the second vertical side rail member 112 and the second vertical frame member 108 may be created from a single piece of material. In some embodiments, the frame members described herein may comprise multiple components. For example, the first vertical side rail member 110 may comprise a vertical frame member attached at the bottom to the first horizontal side frame member 114 and at the top to a horizontal frame member which extends and attaches to the first vertical frame member 106. For another example, the first vertical frame member 106 may comprise multiple vertical components which may be stacked to vary the height of the shelf carriage 100.

The frame components may be designed from one or more materials including but not limited to metals, plastics, woods, composite materials, and other materials with sufficient structure for the shelf carriage to operate. In addition the design features of the components may vary for functional and/or aesthetic purposes. In some embodiments, one or more frame members are formed of hollow components, for example tubular materials, in order to reduce the overall weight of the shelf carriage 100. In some embodiments, the component pieces may include “C” shaped framing. One skilled in the art will recognize the materials and/or frame component designs may vary to account for strength, rigidity, flexibility, weight, and other factors and remain within the scope and spirit of the present disclosure.

In some embodiments, the shelf carriage 100 may be dimensioned to correspond with specifically sized shelving. In some embodiments, the shelf carriage 100 may be designed to vary dimensions for use with differently sized shelves. For example, the transverse frame member 118 and the horizontal back frame members 102 and 104 may be adjustable such that the width between side components may be varied to fit different shelf widths. As another example, the horizontal side frame members 114 and 116 may be adjustable to accommodate shelves with different depths.

In some embodiments, the shelf carriage 100 includes mobility components, such as the four casters 124, which facilitate movement of the shelf carriage 100. One skilled in the art will recognize that other mobility components used in conjunction with or instead of one or more of the casters 124, may include other wheels, rails, ball bearings, and other mobility components. In some embodiments, the casters 124 may include a locking feature to prevent movement when locked. In some embodiments, the shelf carriage 100 may incorporate or operate in conjunction with motorized components to facilitate movement of the shelf carriage. For example, a motorized device may be operable to connect to pull and/or push the shelf carriage 100.

In this embodiment, the shelf carriage 100 also includes the strap 126 which is shown approximately in the center of the back portion of shelf carriage 100. The position of the strap 126 may vary due to various design elements including folding characteristics of the shelf carriage 100, the number of straps 126 incorporated in the shelf carriage 100, and/or the design features of the shelves to be stored and/or moved using the shelf carriage 100. In some embodiments, the position of the strap 126 may be variable.

In this embodiment, one end of the strap 126 is attached to the upper back frame member 102 and the other end includes a first strap connection 128. The first strap connection 128 is connectable to second strap connection 130 which is attached to transverse frame member 118. During operation for storing and/or carrying shelving, the strap 126 may be placed over the shelves and attached using an operative connection between the strap connections 128 and 130 in order to secure the shelves to the shelf carriage 100.

In some embodiments, during operation a user may load the shelf carriage 100 by placing a shelf in the bottom of the shelf carriage 100. In some embodiments, the transverse frame member 118 and the top surface of the horizontal side frame members 114 and 116 support the shelf. The front surface of the vertical frame members 106 and 108 prevent the shelf from sliding or falling out the back of shelf carriage 100. The vertical side rail members 110 and 112 prevent the shelf from sliding or falling out the sides of shelf carriage 100. As the user loads additional shelves, each is supported by the shelf below and contained within the area defined by the front surface of the vertical frame members 106 and 108 and the vertical side rail members 110 and 112.

In some embodiments, the user may also secure the shelves in place from the front using the strap 126. The casters 124 make moving the shelf carriage 100 easier during the rearranging process.

In some embodiments, the height of the shelf carriage 100 may be variable. In such embodiments, the height may be set to correspond with the height of the stack of shelves stored or transported on the shelf carriage 100. In some embodiments, the upper back frame member 102 may be variable such that the height of the upper back frame member 102 may be set to facilitate improved operation of the strap 126.

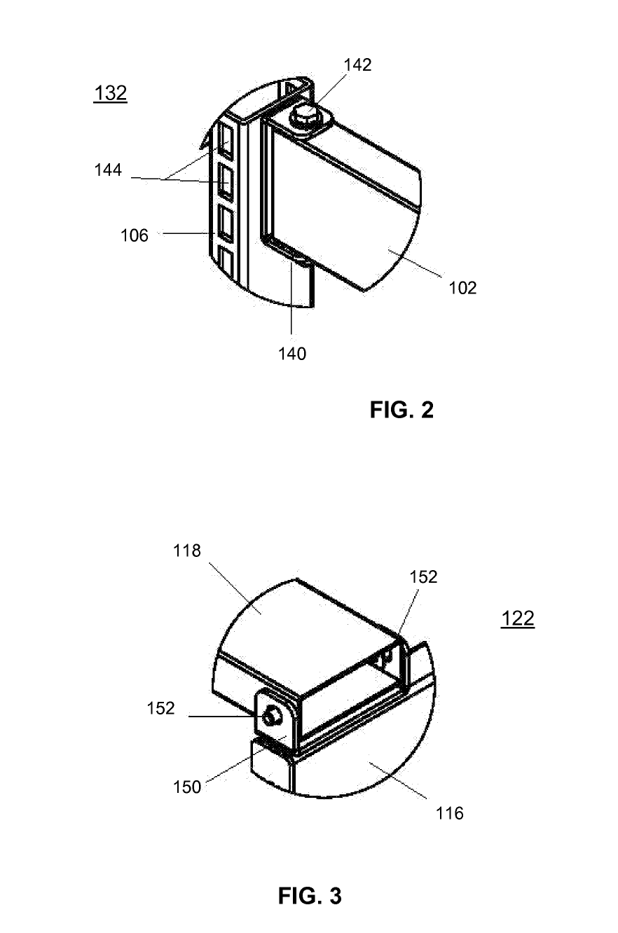

FIG. 2 depicts an exploded view of an embodiment of the hinge 132 connecting the first vertical frame member 106 with the upper back frame member 102. In this embodiment, the hinge 132 comprises a hinge bracket 140 and a pin 142. The hinge bracket 140 is shown as a “C” shaped bracket attached to the first vertical frame member 106. In this embodiment, the pin 142 passes through the top and bottom extended portions of the hinge bracket 140 and one end of the upper back frame member 102. The connection allows for axial movement between the first vertical frame member 106 and the upper back frame member 102 around the pin 142 which acts as a pivot point.

The pin 142 may comprise any pin, pole, bolt or other components which may facilitate a rotatable connection between the hinge bracket 140 and the upper back frame member 102. The pin 142 may be a pole, bolt, rod, cylinder or other item which may pass through the extensions of bracket 140 and the end of the upper back frame member 102. In some embodiments, the pin 142 does not pass through both extensions of the bracket 140. For example, the pin 142 may be a treaded connection which may connect with corresponding threads in one extension of the bracket 140.

One skilled in the art will recognize that other hinge or rotatable connection designs and mechanisms may be utilized and remain within the scope and spirit of the present disclosure. For example, instead of the “C” shaped bracket and independent pin, hinge bracket 140 may comprise a “U” shaped bracket wherein one side of the “U” attaches to the first vertical frame member 106 and the second side of the “U” is cylindrical and fits a passage way in the end of the upper back frame member 102.

In some embodiments, the hinge 132 is both rotatable and removable. For example, the upper back frame member 102 may include spring loaded protrusions which may be compressed to connect or disconnect the hinge 132, and the protrusions may be fitted to allow rotation when connected to the hinge 132.

In addition, FIG. 2 shows the shelf support connections as openings 144 located in the front portion of the first vertical frame member 106. In some embodiments, the openings 144 are designed to accept shelf brackets or other protrusions or hooks associated with a shelf to connect the shelf to the shelf carriage 100 and support the shelf when in storage or during transport. Each of the openings 144 may be dimensioned and arranged to receive the distal end of a shelf hook. One skilled in the art will recognize that the design of openings 144 may vary to correspond with the shape and arrangement of one or more shelf brackets associated with the shelves. In some embodiments, other mechanisms and designs for the shelf support connections may be used to hold the shelves while in storage or during transport. In some embodiments, the openings 144 operate to reduce the overall weight of the shelf carriage 100 while maintaining sufficient structure to hold shelves.

In some embodiments, the shelf carriage 100 may be designed such that some shelves may be connected to the shelf carriage 100 and some shelves are supported by either the bottom structure as discussed above and/or upon the connected shelves. In some embodiments, the shelves may be secured from the front using strap 126.

FIG. 3 depicts an exploded view of an embodiment of the second connection 122 connecting the transverse frame member 118 with the second horizontal side frame member 116. In this embodiment, the second connection 122 is a detachable connection comprising a bracket 150 and a set of push buttons 152. One skilled in the art will recognize that the push buttons 152 may comprise any compressible protrusions or other mechanism which may operate as a detachable connection. The bracket 150 is shown as a “C” shaped bracket attached to the second horizontal side frame member 116. In this embodiment, the push buttons 152 are integrated into at least one end of transverse frame member 118. When the push buttons 152 are not compressed, they engage passages in the extended portions of bracket 150 and secure the transverse frame member 118 with the second horizontal side frame member 116. When the push buttons 152 are compressed, they may disengage the passages in the extended portions of bracket 150 and allow the transverse frame member 118 to be disconnected from the second horizontal side frame member 116.

One skilled in the art will recognize that other designs and mechanisms for removable or detachable connections may be utilized for second connection 122 and remain within the scope and spirit of the present disclosure. For example, the second connection may comprise a pair of complimentary fitted components—such as an upward “C” shaped bracket on the second horizontal side frame member 116 and a downward “C” shaped bracket on the transverse frame member 118—which use gravity and the weight of the stored shelves to hold the frame together.

FIG. 4 depicts an embodiment of shelf carriage 100 in a closed or folded state. In this embodiment, the shelf carriage 100 is folded to minimize the floor footprint. The transverse frame member 118 has been disconnected from the second horizontal side frame member 116. In this embodiment, the second connection 122 is disconnected such that the bracket 150 and protrusions of the push buttons 152 are no longer engaged to hold the frame in the open state. The disconnected transverse frame member 118 is rotated to a vertical position at first connection 120 which is a rotatable connection in this embodiment. The side components are rotated inward to the back of shelf carriage 100 around the hinges 132 which provide a rotatable connection between the horizontal back frame members 102 and 104 and the vertical frame members 106 and 108. This reduces the depth and therefore the overall footprint of the shelf carriage 100 for storage without the shelves.

In some embodiments, the height of the shelf carriage 100 may also be variable. For example, the vertical components of the shelf carriage 100 may consist of vertical components that may slide up and down as needed. In such embodiments, the overall area of the shelf carriage 100 may be further reduced and the shelf carriage 100 may fit in locations with lower clearance. For example, a section of inventory storage in a back room may have shelving which allows the shelf carriage 100 to be stored under additional stored inventory.

During operation the user may remove the stored shelves from the shelf carriage 100 and elect to collapse the shelf carriage 100 to minimize the footprint of the shelf carriage 100 for storage. In order to collapse the shelf carriage, the user disconnects the transverse frame member 118 from the second horizontal side frame member 116. In this embodiment, the user may push the push buttons 152 of the second connection 122 and disengage the bracket 150 and the push buttons 152. The user then rotates the transverse frame member 118 into a vertical position around the pivot point defined by first connection 120. The user then rotates the side components inward to the back of shelf carriage 100 around the hinges 132 which provide a rotatable connection between the horizontal back frame members 102 and 104 and the vertical frame members 106 and 108.

In some embodiments, the shelf carriage 100 will include a locking mechanism to hold the shelf carriage 100 in the folded position. For example, hinges 132 may include one or more latches that hold the shelf carriage 100 in the folded position. For another example, the shelf carriage 100 may include a removable strap that stretches from first vertical frame member 106 to second vertical frame member 108 around the transverse frame member 118 and the side components to hold the shelf carriage 100 in the folded position.

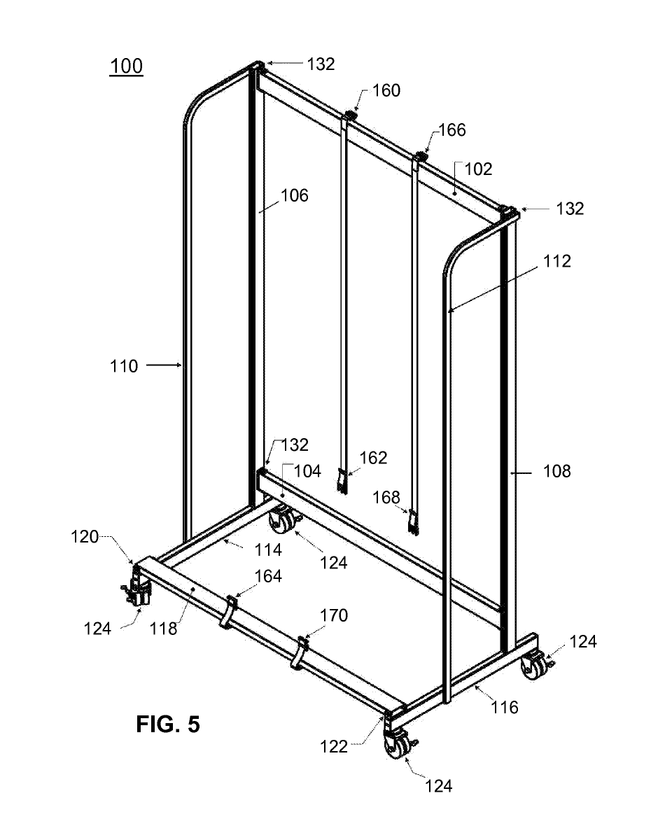

FIG. 5 depicts another embodiment of shelf carriage 100 in an open state. In this embodiment, the shelf carriage 100 includes a first strap 160 and a second strap 166. The first strap 160 and the second strap 166 are shown spaced apart and attached to the upper back frame member 102. At the other end of the first strap 160 from the upper back frame member 102 is a strap connection 162 which is connectable to a base strap connection 164 which is attached to transverse frame member 118. At the other end of the second strap 166 from the upper back frame member 102 is a strap connection 168 which is connectable to a base strap connection 170 which is attached to transverse frame member 118. During operation for storing and/or carrying shelving, the straps 160 and 166 may be placed over the shelves and attached using an operative connection between on the one hand the strap connections 162 and 168 and on the other hand the base strap connections 164 and 170 in order to secure the shelves to the shelf carriage 100.

As an example, an apparatus for storing shelves may comprise a back and two side members each foldably connected to a respective side of the back and moveable between a folded condition substantially adjacent to the back and an open condition substantially perpendicular to the back and a detachable support member adapted, when the apparatus is in the open condition, to extend between the two sides members at a position remote from the back to secure the apparatus in its open position.

The invention being thus described and further described in the claims, it will be obvious that the same may be varied in many ways. Such variations are not to be regarded as a departure from the spirit and scope of the invention and all such modifications as would be obvious to one skilled in the art are intended to be included within the scope of the apparatus and method described.

1. An apparatus for carrying one or more retail shelves comprising
a back;
a first side frame attached to said back by a first rotatable connection, wherein said first side frame comprises a first horizontal frame member and a first vertical frame member;
a second side frame attached to said back by a second rotatable connection, wherein said second side frame comprises a second horizontal frame member and a second vertical frame member; and
a transverse frame member attached to said first side frame by a third rotatable connection and attachable to said second side frame by a releasable connection;
wherein said apparatus is able to transition between a first condition and a second condition,
wherein said first condition comprises said transverse frame member attached to said second side frame; and
wherein said second condition comprises said transverse frame member unattached from said second side frame, and said first side frame and said second side frame folded inward toward said back.

2. The apparatus of claim 1, wherein said first vertical frame member comprises a first shelf support connection and wherein said second vertical frame member comprises a second shelf support connection.

3. The apparatus of claim 2, wherein said first shelf support connection comprises at least one first opening dimensioned and arranged to receive a distal end of a first shelf hook; and wherein said second shelf support connection comprises at least one second opening dimensioned and arranged to receive a distal end of a second shelf hook.

4. The apparatus of claim 3, wherein said first side frame comprises a first side rail and said second side frame comprises a second side rail.

5. The apparatus of claim 3, further comprising four casters.

6. The apparatus of claim 3, further comprising at least one strap, wherein said strap is connectable between said back and said transverse frame member.

7. The apparatus of claim 2, further comprising at least one mobility component.

8. The apparatus of claim 2 wherein the back comprises upper and lower back frame members and the first and second side frames are attached to the respective outer ends of the back frame members.

9. The apparatus of claim 1, wherein said first side frame comprises a first side rail and said second side frame comprises a second side rail.

10. The apparatus of claim 9, further comprising at least one strap, wherein said strap is connectable between said back and said transverse frame member.

11. A shelf carriage comprising
a back comprising a plurality of back horizontal frame members;
a first side frame attached to said back by a first rotatable connection, wherein said first side frame comprises a first side horizontal frame member, a first vertical frame member and a first side rail;
a second side frame attached to said back by a second rotatable connection, wherein said second side frame comprises a second side horizontal frame member, a second vertical frame member and a second side rail; and
a transverse frame member attached to said first side horizontal frame member by a third rotatable connection and attachable to said second side horizontal frame member by a releasable connection;
wherein said shelf carriage is able to transition between an open condition and a closed condition,
wherein said open condition comprises said transverse frame member attached to said second side horizontal frame member; and
wherein said second condition comprises said transverse frame member unattached from said second side horizontal frame member, and said first side frame and said second side frame folded inward toward said back.

12. The shelf carriage of claim 7, wherein when in said open condition said transverse frame member, said first side horizontal frame member and said second horizontal frame member are positioned to support at least one shelf.

13. The shelf carriage of claim 8, wherein when in said open condition said first side vertical frame member, said first side rail, said second side vertical frame member and said second side rail are positioned to limit movement of at least one shelf.

14. The shelf carriage of claim 7, further comprising four casters.

15. The shelf carriage of claim 7, wherein a depth between said transverse frame member and said back is based upon a shelf depth.

16. The shelf carriage of claim 7, wherein a depth between said transverse frame member and said back is variable.

17. The shelf carriage of claim 7, wherein a width between said first side rail and said second rail is based upon a shelf width.

18. The shelf carriage of claim 7, wherein a width between said first side rail and said second rail is variable.

19. The shelf carriage of claim 7, further comprising at least one strap, wherein said strap is connectable between said back and said transverse frame member.

20. The shelf carriage of claim 7, wherein said first side vertical frame member, said first side rail, said second side vertical frame member and said second side rail comprise slide components to facilitate variation in the height of said shelf carriage.

21. An apparatus for storing shelves comprising upper and lower back frame members and two side frames each foldably connected to the respective outer ends of the back frame members and moveable between a folded condition substantially adjacent to the back frame members and an open condition substantially perpendicular to the back frame members and a detachable support member adapted, when the apparatus is in the open condition, to extend between the two side frames at a position remote from the back frame members to secure the apparatus in its open position.
